(19) United States
(12) Patent Application Publication
(10) Pub. No.: US 2024/0378968 A1
(43) Pub. Date: Nov. 14, 2024

(54) SYSTEM AND METHOD FOR USING SCRATCH-OFF LOTTERY TICKETS

(71) Applicant: Pollard Banknote Limited, Winnipeg (CA)

(72) Inventors: Nancy Bettcher, Winnipeg (CA); Jean-Paul Laurendeau, Winnipeg (CA); Gurbir Dhillon, Winnipeg (CA); Shelley Sacramento, Winnipeg (CA); Karsten Roche, Boston, MA (US); Todd Seier, Winnipeg (CA); Jessica Nakucyj, Winnipeg (CA); Victoria Penner, Winnipeg (CA); Michael Brickwood, Winnipeg (CA)

(21) Appl. No.: 18/660,454

(22) Filed: May 10, 2024

Related U.S. Application Data
(60) Provisional application No. 63/501,319, filed on May 10, 2023.

(51) Int. Cl. G07F 17/32; G06K 19/06

(52) U.S. Cl. CPC G07F 17/329; G06K 19/06028; G06K 19/06037

(57) ABSTRACT

Disclosed is a game system comprising a central host computer having various ticket specific computer files, a retail establishment having a plurality of lottery tickets and a POS system through which the plurality of lottery tickets are purchased, and a player device, wherein the lottery tickets have at least one play area covered by a scratch off coating and at least one of a website, a QR code, and a bar code readable by the player device, wherein when the one of the QR code and the bar code is read by the player device or when the website is entered into the player device the player device receives instructions from a server to select avatars and game preferences.

### BACKGROUND

### 1. Field

Example embodiments relate to a system and method for using scratch-off lottery tickets.

### 2. Description of the Related Art

Scratch off lottery tickets are fairly old in the art and have enjoyed immense popularity. Generally speaking, scratch off lottery tickets have play areas that are scratched off and compared to winning criteria often printed on the ticket. For example, some scratch off lottery tickets are designed as blackjack games where the winner is required to scratch off a pair of cards in the play area having a value higher than a predetermined pair printed on the ticket to win the game.

### SUMMARY

The inventor appreciates the traditional scratch off lottery ticket but believes the experience can be greatly enriched by combining elements of a traditional scratch off lottery ticket with digital play. To that end, the inventor designed a game system which is physical in part and digital in part, where partial game information is contained in a physical scratch off lottery ticket and, in one embodiment, other game information is contained digitally and shared after the lottery ticket is purchased. In another embodiment, partial game information is contained in a physical scratch off lottery ticket along with a link to a website which may offer the purchaser an enhanced online experience associated with the ticket. In this latter embodiment, whereas the ticket enables a purchaser to have an online experience, the purchaser is not required to enjoy the online experience to redeem the ticket since win/loss information for the ticket is predetermined. That is, for this latter embodiment, a consumer might simply purchase and thereafter redeem the ticket without going through the online experience. Disclosed is a game system comprising a central host computer having various ticket specific computer files, a retail establishment having a plurality of lottery tickets and a POS system through which the plurality of lottery tickets are purchased, and a player device, wherein the lottery tickets have at least one play area covered by a scratch off coating and at least one of a website and QR code readable by the player device, wherein when the QR code is read by the player device (or the website is entered into the player device) the player device receives instructions from a server to select avatars and game preferences and thereafter initiates a game play.

### BRIEF DESCRIPTION OF THE DRAWINGS

Example embodiments are described in detail below with reference to the attached drawing figures, wherein:

FIG. 1 is a view of a game system in accordance with example embodiments;

FIGS. 2A-2C illustrate a nonlimiting example embodiment of a lottery ticket usable with the game system in accordance with example embodiments;

FIGS. 3A-3C illustrate a nonlimiting example embodiment of a lottery ticket usable with the game system in accordance with example embodiments;

FIGS. 4A-4C illustrate a nonlimiting example embodiment of a lottery ticket usable with the game system in accordance with example embodiments;

FIGS. 5A-5C illustrate a nonlimiting example embodiment of a lottery ticket usable with the game system in accordance with example embodiments; and

FIGS. 6A-6C illustrate a nonlimiting example embodiment of a lottery ticket usable with the game system in accordance with example embodiments.

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to a system and method for using scratch-off lottery tickets.

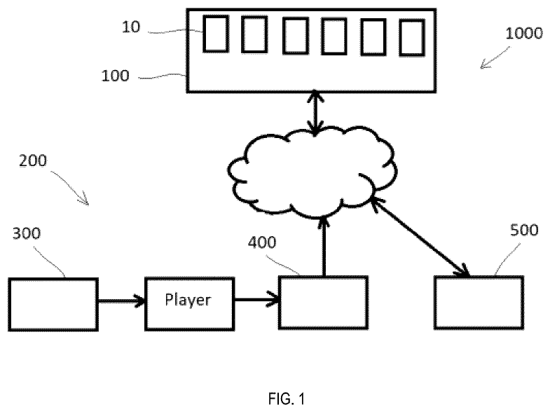

FIG. 1 is a view of a game system 1000 in accordance with a nonlimiting example embodiment. As shown in FIG. 1, the game system 1000 includes a central host computer 100 having various ticket specific computer files 10, a retail establishment 200 where lottery tickets 300 may be purchased through a POS system 400, and a player device 500 (for example, a smartphone, tablet, computer). At the time of purchase the lottery tickets 300 are scanned and identified by the central host computer 100. For example, the retail clerk may use a portable scanner to scan a validation code or ticket identifier code and transmit the code to the central host computer 100 which, in one embodiment, identifies the lottery tickets 300 as being legitimately purchased (activated) for play and redemption in a computer file 10 associated with the lottery tickets 300. It is understood this exemplary game system 1000 is not meant to limit the invention as lottery tickets 300 are not required to be validated on an individual basis since the lottery tickets 300 may, in another embodiment, be part of a book of lottery tickets which, as a whole, is validated.

In example embodiments the lottery tickets 300 may include various play areas covered by a scratch off coating. The play areas may be associated with a prize amount, for example, a dollar amount or some other prize such as, but not limited to, a car, a boat, or a microwave. Also on the lottery tickets are areas allowing the consumer to electronically connect to the cloud via the player device 500. The cloud may, in turn, connect to a server (which may or may not be the central host computer 100) which interacts with the consumer through the player device 500. The aforementioned areas may be covered by a scratch off coating and may include a QR code, a bar code, or a website address allowing the user to connect to the server. The server may send data to the player device 500 to generate images and automations which enhance the player experience. The consumer may interact with the server through the player device 500 to upload preferences, play games, and understand what winnings the consumer has won. In one embodiment, the QR codes for the each of the lottery tickets 300 are unique. For example, a retail establishment that has in inventory lottery tickets 300 for sale, each lottery ticket 300 may have a unique QR code and each QR code may contain game and lottery ticket information which may be sent to a computer system for purpose of game play.

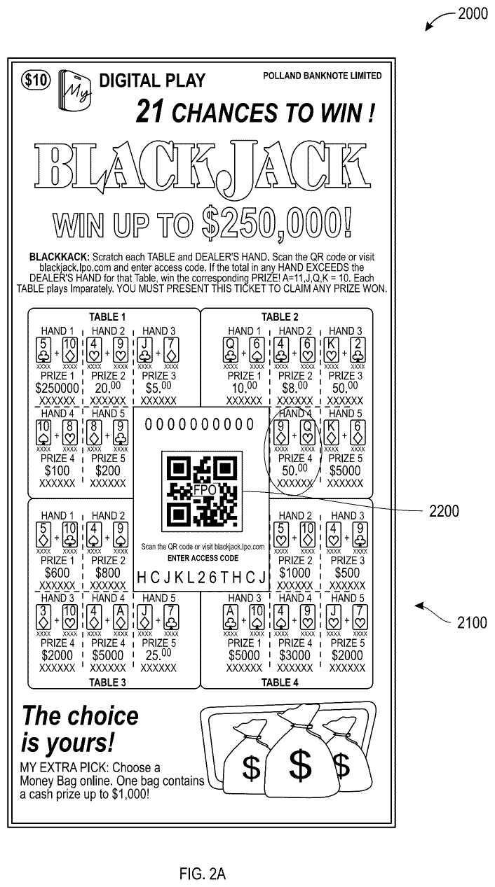

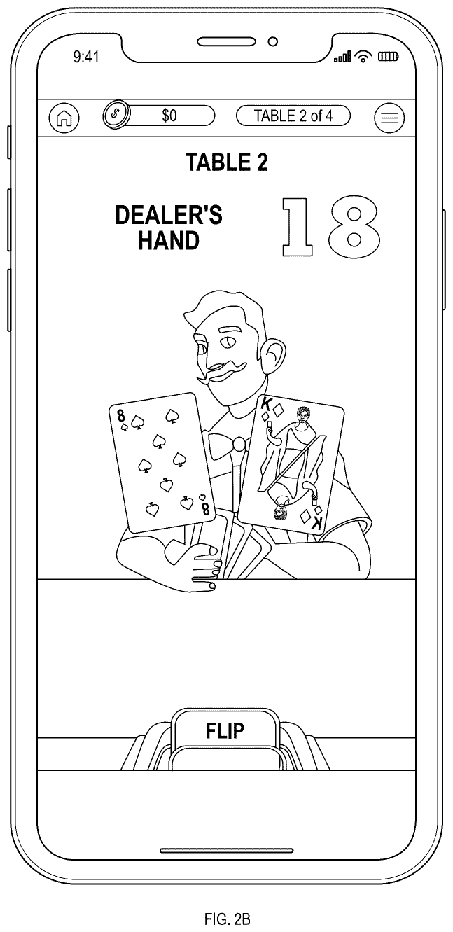

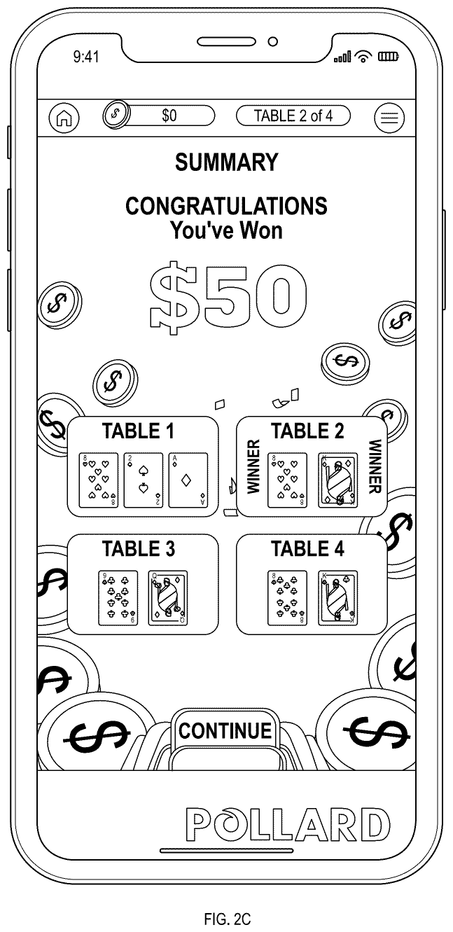

FIG. 2A is a view of a lottery ticket 2000 in accordance with a nonlimiting example embodiment. The lottery ticket 2000 may be substantially the same as the previously described lottery ticket 300. As shown in FIG. 2, the nonlimiting lottery ticket 2000 is specifically configured for a Black Jack game. In this nonlimiting example embodiment there are four play areas 2100 identified as Table 1, Table2, Table 3, and Table 4 which, when purchased, is generally covered by scratch-off coating. Though four play areas 2100 are illustrated, this is for purposes of illustration only as the inventive concepts may cover more or less than four play areas. In the middle of the lottery ticket 2000 is QR code and/or a website 2200 which allows the purchaser to interface with a server which generates a casino like experience on the consumer's player device 500. The QR code and/or website 2200 may also be covered with a scratch off coating when the ticket is purchased. For example, once a ticket 2000 is purchased and activated by the game system 1000, the consumer may scratch off the coatings covering the play areas 2100 and the QR code and/or website 2200. The consumer may then use the player device 500 to either scan the QR code (if present) or input the website address to the player device 500. Regardless, scanning the QR code or entering the website allows the consumer to interface with a server which generates a casino like experience at the player device 500. For example, the player device 500 may be a smart phone having a touch screen and the player device 500 may receive data from the server enabling the player device 500 to generate various images and animations. The player device 500 may send data to the computer system so the computer system may undertake the necessary actions and return data to the player device 500. In one example, the server may have a memory and a processor enabling the server to generate one or more dealer avatars and casino themes, which may be selected by the user via the player device 500. For example, the server may send data to the player device 500 allowing the consumer to select an avatar for a dealer, for example, the consumer may pick a male dealer, a female dealer, a robotic dealer, and so on. The server may also send additional data to the consumer to allow the consumer to select the background of the computer generated casino, the style of cards, and/or whether people walk by in the computer generated casino. Once selected, the dealer avatar may undertake various actions, for example, shuffling an electronic deck and revealing hands for each of play areas 2100. For example, the dealer may shuffle the digital cards and then reveal dealer's hand associated with Table 1. The consumer would then compare his or her hand in Table 1 against the dealer's hand and the consumer may win a prize which may be associated with the winning hand. For example, FIG. 2B illustrates a computer generated dealer and hand on the consumer's device 500. In this nonlimiting example embodiment, the dealer's hand for table 2 is generated. Since table 2 of the lottery ticket 2000 has a pair higher than the dealer's pair, the consumer wins the associated amount which, in this case, is $50. In one nonlimiting example embodiment, a running total may be presented on the top of the computer screen. This process, in this nonlimiting example embodiment, is repeated for Table 3 and Table 4. A summary screen, for example 2C, may be generated by the computer system, may present a summary of the winnings associated with the lottery ticket 2000 which may thereafter be redeemed.

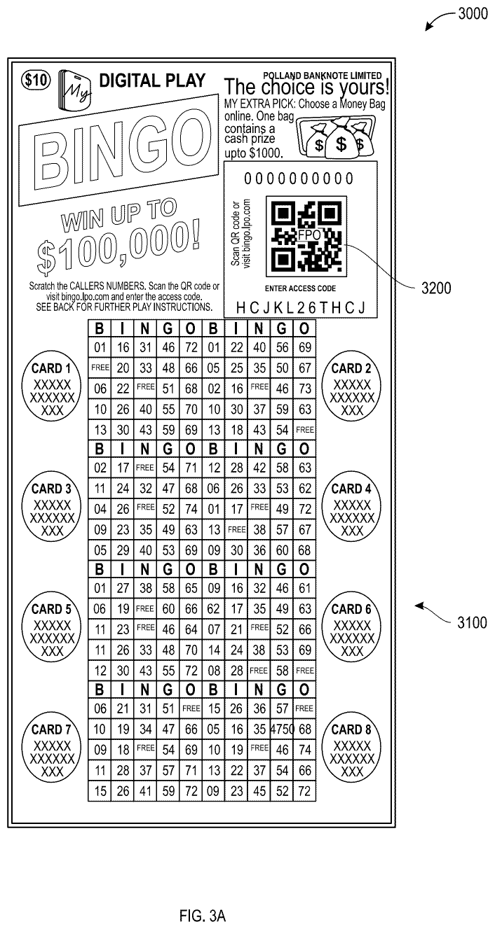

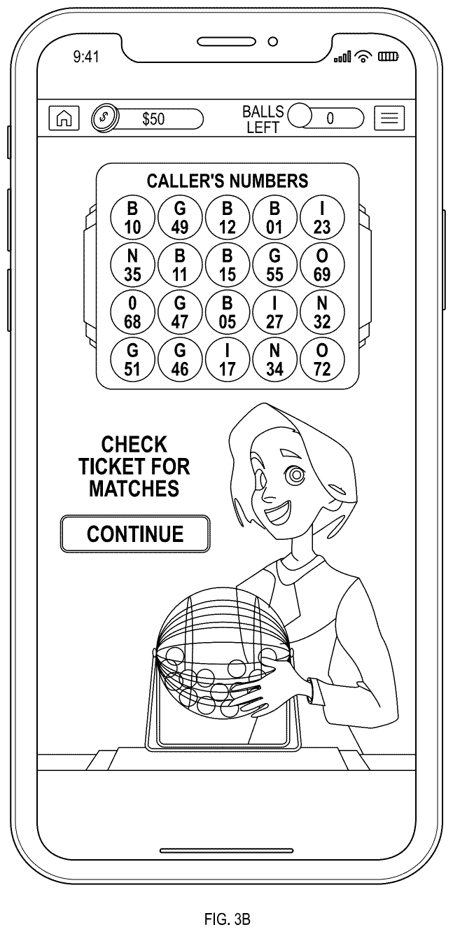

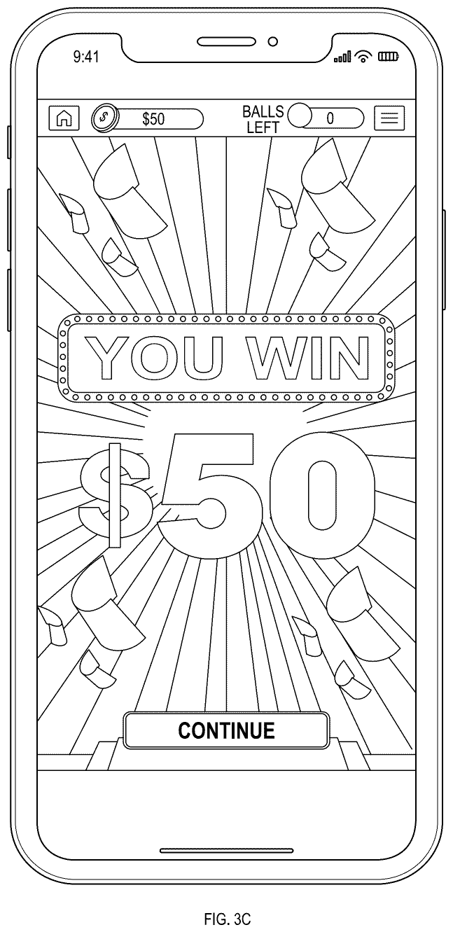

FIG. 3A is a view of a lottery ticket 3000 in accordance with another nonlimiting example embodiment. The lottery ticket 3000 may be substantially the same as the previously described lottery ticket 300. As shown in FIG. 3A, the nonlimiting lottery ticket 3000 is specifically configured for a Bingo game. In this nonlimiting example embodiment there are eight play areas 3100 identified as Card 1, Card 2, Card 3, Card 4, Card 5, Card 6, Card 7, and Card 8 which, when purchased, is generally covered by scratch-off coating. Though eight play areas 3100 are illustrated, this is for purposes of illustration only as the inventive concepts may cover more or less than eight play areas. In the upper right of the lottery ticket 3000 is QR code and/or a website 3200 which allows the purchaser to interface with a computer system which generates a bingo-hall like experience. The QR code and/or website 3200 may also be covered with a scratch off coating when the ticket is purchased. For example, once a ticket 3000 is purchased and activated by the game system 1000, the consumer may scratch off the coatings covering the play areas 3100 and the QR code and/or website 3200. The consumer may then use the player device 500 and either scan the QR code (if present) or input the website address to the player device 500. Regardless, scanning the QR code or entering the provided website allows the consumer to interface with a server (which may be part of the central host computer 100 or may be a second computer) which generates a bingo-hall like experience on the player device 500. In one example, the server may have a memory and a processor enabling the computer to generate one or more bingo caller avatars and bingo-hall themes on the player device 500 (noting the caller avatars and themes may be selected by the purchaser). For example, the server may prompt the consumer to select a bingo caller which may be a male bingo caller, a female bingo caller, a robotic bingo caller, and so on. The server may also prompt the consumer to select the background of the computer generated bingo-hall, the style of balls, and/or whether people walk by in the computer generated bingo-hall. Once selected, the server may cause the bingo caller avatar to undertake various digital actions, for example, animate a digital cage, select digital balls from the digital cage, announce the balls selected from the digital cage, and provide a summary of the called balls. The consumer may then check his or her cards for a bingo and if the player wins. In FIG. 3A, for example, card 4 is shown as having a winning sequence and a value of $50. As with the previous embodiment, a summary screen, for example 3C, may be generated by the computer system, may present a summary of the winnings associated with the lottery ticket 3000 which may thereafter be redeemed.

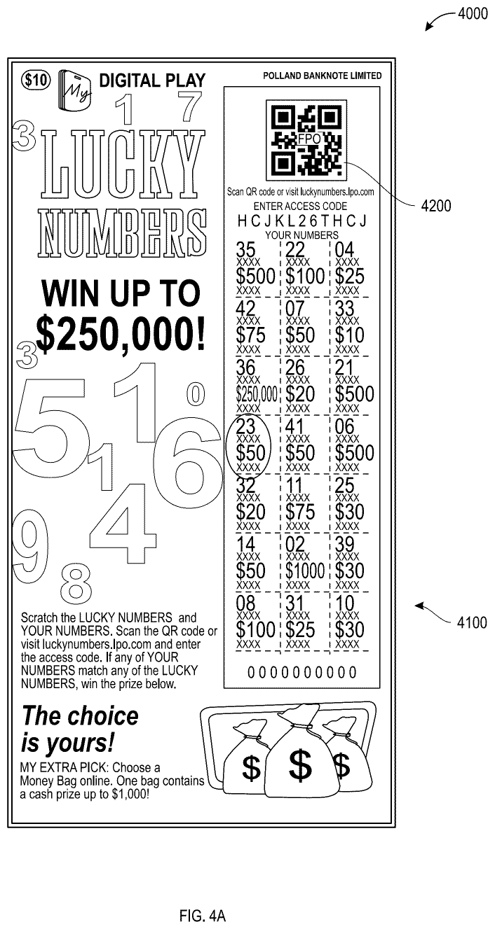

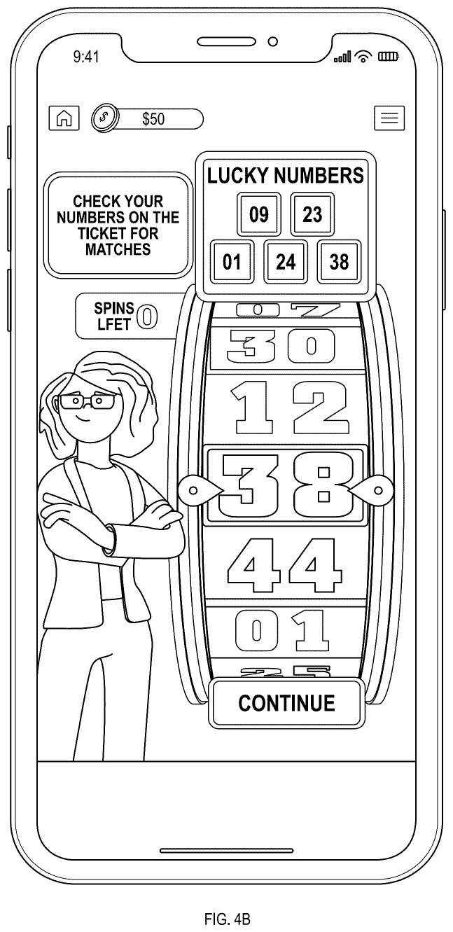

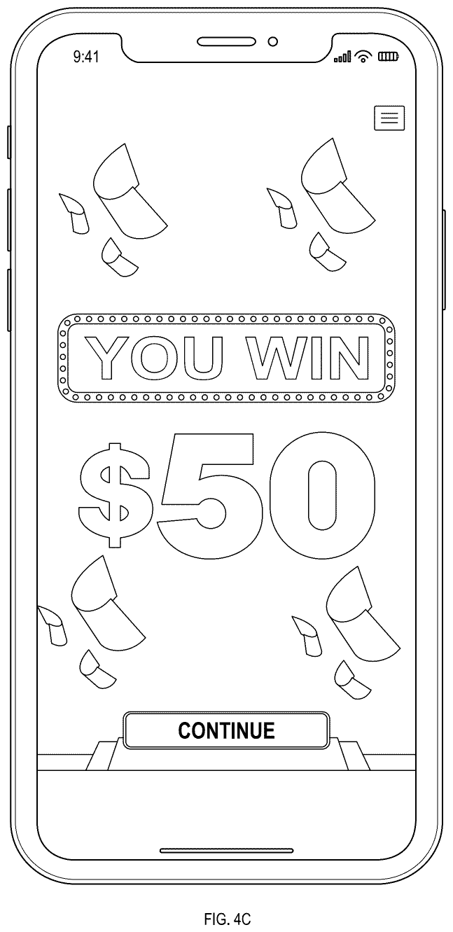

FIG. 4A is a view of a lottery ticket 4000 in accordance with another nonlimiting example embodiment. The lottery ticket 4000 may be substantially the same as the previously described lottery ticket 300. As shown in FIG. 4A, the nonlimiting lottery ticket 4000 is specifically configured for a “Spin the wheel” game. In this nonlimiting example embodiment there are twenty one areas 4100 identified as twenty one lucky numbers (arranged in 7 rows and 3 columns) which, when purchased, is generally covered by scratch-off coating. Though twenty one play areas 4100 are illustrated, this is for purposes of illustration only as the inventive concepts may cover more or less than twenty one play areas. In the upper portion of the lottery ticket 4000 is QR code and/or a website 4200 which allows the purchaser to interface with a computer system which generates a “spin the wheel” like experience. The QR code and/or website 4200 may also be covered with a scratch off coating when the ticket 4000 is purchased. For example, once a ticket 4000 is purchased and activated by the game system 1000, the consumer may scratch off the coatings covering the play areas 4100 and the QR code and/or website. The consumer may then use the player device 500 and either scan the QR code (if present) or input the website address to the player device 500. Regardless, scanning the QR code or entering the provided website allows the consumer to interface with a computer system (which may be part of the central host computer 100 or may be a second computer) which generates a “spin the wheel” like experience. In one example, the computer may have a memory and a processor enabling the computer to generate one or more avatars to spin a digital wheel as well as various themes, for the style of the wheel, the colors of the numbers, and background colors. For example, the consumer may pick a male “spin the wheel” caller, a female “spin the wheel” caller, a robotic “spin the wheel” caller, and so on. Once selected, caller avatar may undertake various actions, for example, spin a digital wheel until it stops revealing a “lucky number”, which, in FIG. 4B, is 38. The caller, in one nonlimiting example embodiment, may be prompted to “spin the wheel” by a consumer that presses a “continue” button which may be generated on the player device 500. After the “lucky number” is revealed the game may be paused to allow the consumer to check his card and play can be initiated once again by the consumer pressing the “continue” button. In the event one of the lucky numbers on the card 4000 matches one of the lucky numbers associated with the digital wheel, the consumer wins the prize associated with the lucky number on the card. A running total may be kept and displayed on the player device 500. As with the previous embodiments, a summary screen, for example 4 C, may be generated by the computer system, may present a summary of the winnings associated with the lottery ticket 4000 which may thereafter be redeemed.

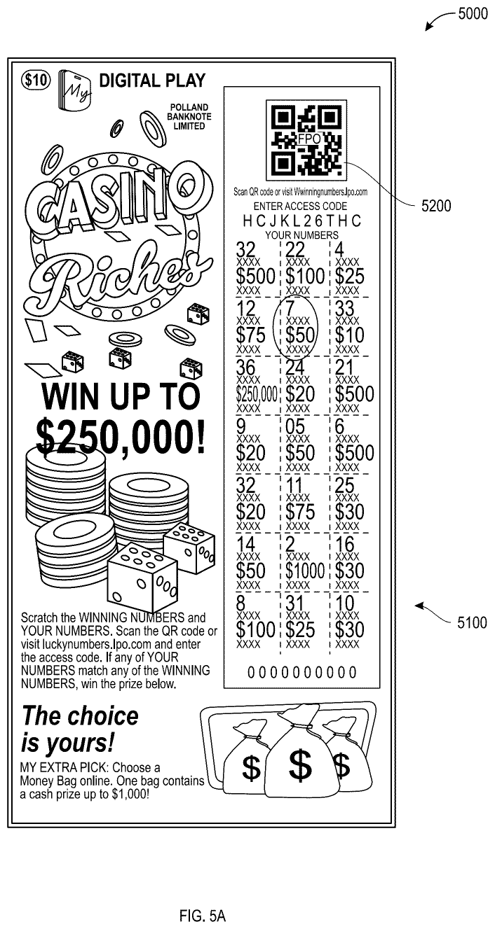

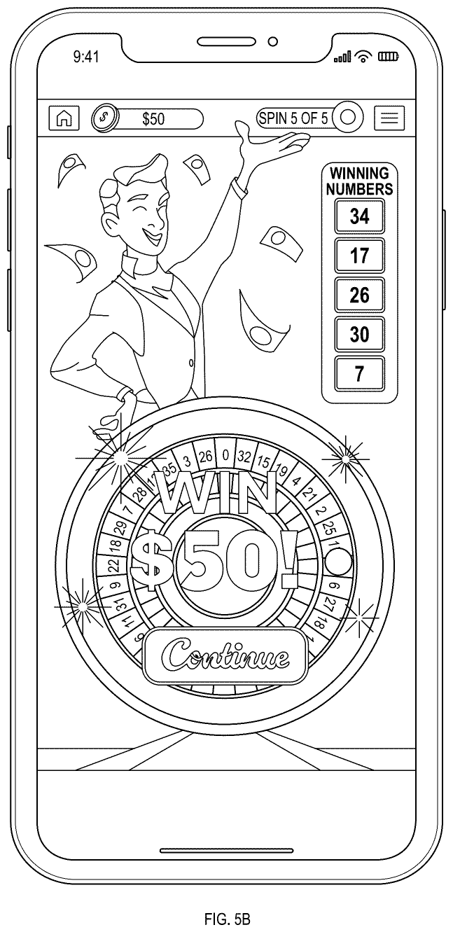

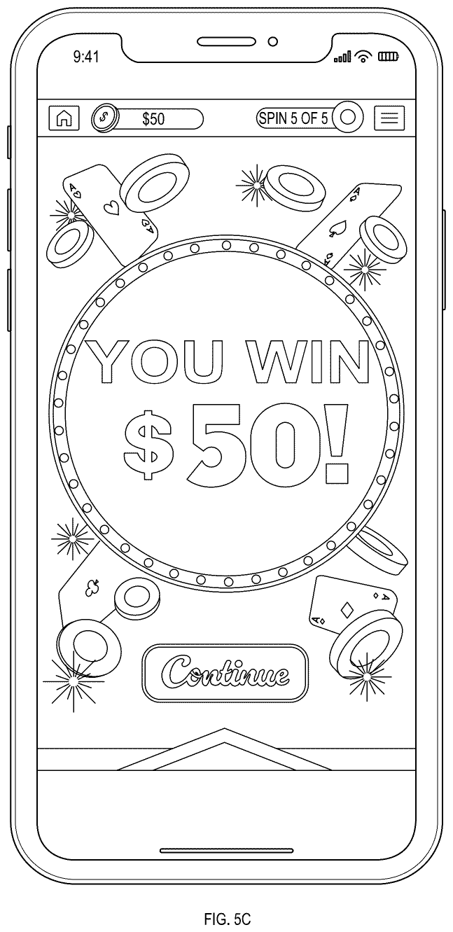

FIG. 5A is a view of a lottery ticket 5000 in accordance with another nonlimiting example embodiment. The lottery ticket 5000 may be substantially the same as the previously described lottery ticket 300. As shown in FIG. 5A, the nonlimiting lottery ticket 5000 is specifically configured as a roulette game. In this nonlimiting example embodiment there are twenty one play areas 5100 identified as twenty one roulette numbers (arranged in 7 rows and 3 columns) which, when purchased, is generally covered by scratch-off coating. Though twenty one play areas 5100 are illustrated, this is for purposes of illustration only as the inventive concepts may cover more or less than twenty one play areas. In the upper portion of the lottery ticket 5000 is QR code and/or a website 5200 which allows the purchaser to interface with a computer system which generates a roulette game like experience. The QR code and/or website 5200 may also be covered with a scratch off coating when the ticket 5000 is purchased. For example, once a ticket 5000 is purchased and activated by the game system 1000, the consumer may scratch off the coatings covering the play areas 5100 and the QR code and/or website 5200. The consumer may then use the player device 500 and either scan the QR code (if present) or input the website address to the player device 500. Regardless, scanning the QR code or entering the provided website allows the consumer to interface with a server (which may be part of the central host computer 100 or may be a second computer) which generates a roulette like experience. In one example, the server may have a memory and a processor enabling the server to generate one or more avatars to spin a digital roulette wheel as well as various themes, for the style of the wheel, the colors of the numbers, and background colors. For example, server may prompt the consumer to pick a roulette caller which may be, but is not limited to, a male roulette caller, a female roulette caller, a robotic roulette caller, and so on. Once selected, caller avatar may undertake various actions, for example, spinning a digital roulette wheel and dropping a digital ball on the digital roulette wheel until it stops revealing a “number”, which, in FIG. 5B, is 34. The roulette caller, in one nonlimiting example embodiment, may be prompted to spin the roulette wheel and drop the ball by a consumer that presses a “spin” button which may be generated on the player device 500. After the “number” is revealed, the game may be paused to allow the consumer to check his or her card and play can be initiated once again by the consumer pressing a “continue” button to generate additional numbers. In the event one of the lucky numbers on the card 5000 matches one of the lucky numbers associated with the digital roulette wheel, the consumer wins the prize associated with the lucky number on the card. A running total may be kept and displayed on the player device 500. As with the previous embodiments, a summary screen, for example 5C, may be generated by the computer system, may present a summary of the winnings associated with the lottery ticket 4000 which may thereafter be redeemed.

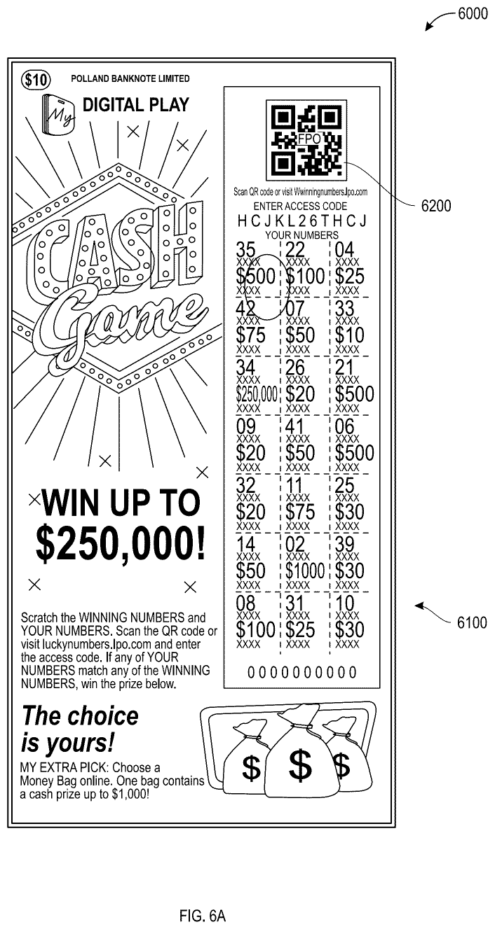

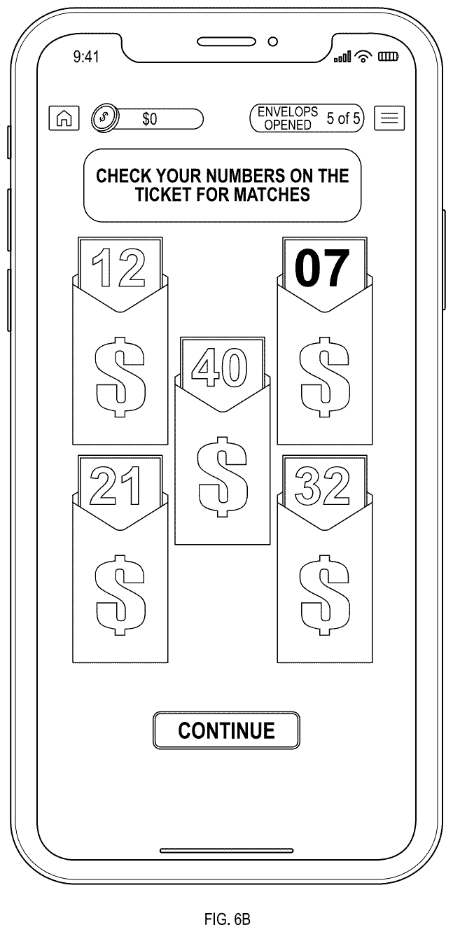

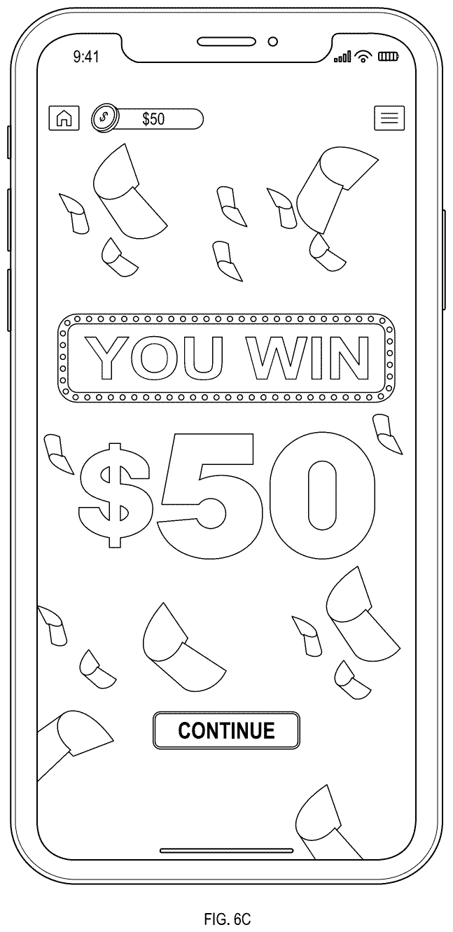

FIG. 6A is a view of a lottery ticket 6000 in accordance with another nonlimiting example embodiment. The lottery ticket 6000 may be substantially the same as the previously described lottery ticket 300. As shown in FIG. 6A, the nonlimiting lottery ticket 6000 is specifically configured as a cash game. In this nonlimiting example embodiment there are twenty one play areas 6100 identified as twenty one numbers (arranged in 7 rows and 3 columns) which, when purchased, is generally covered by scratch-off coating. Though twenty one play areas 6100 are illustrated, this is for purposes of illustration only as the inventive concepts may cover more or less than twenty one play areas. In the upper portion of the lottery ticket 6000 is QR code and/or a website 6200 which allows the purchaser to interface with a computer system which generates a cash game like experience. The QR code and/or website 6200 may also be covered with a scratch off coating when the ticket 6000 is purchased. For example, once a ticket 6000 is purchased and activated by the game system 1000, the consumer may scratch off the coatings covering the play areas 6100 and the QR code and/or website. The consumer may then use the player device 500 and either scan the QR code (if present) or input the website address to the player device 500. Regardless, scanning the QR code or entering the provided website allows the consumer to interface with a computer system (which may be part of the central host computer 100 or may be a second computer) which generates a cash game like experience. In one example, the computer may have a memory and a processor enabling the computer to generate one of various themes (for example, a tornado, claw machine, or sandstorm). The computer, in this nonlimiting example embodiment, may also generate envelopes containing numbers. A user may tap each envelop to reveal the number enclosed in the digital envelope and if any one of the numbers matches the players numbers, the player wins the prize associated with the envelop. A running total may be kept and displayed on the player device 500. As with the previous embodiments, a summary screen, for example 5C, may be generated by the computer system, may present a summary of the winnings associated with the lottery ticket 4000 which may thereafter be redeemed.

Applicant's inventive concepts cover additional features. For example, in some embodiments, data to generate an online experience may be embedded in the QR code. For example, in the case of the Black Jack game, the QR code may have data indicating the ticket 2000 is associated with a Black Jack game. Additionally, other information, for example, the hands in each of the play areas, may be contained in the QR code as well as the winnings and may have additional data such as the hands to be drawn by an avatar. Data in the QR codes of the other exemplary games may include similar data. Also, while it is anticipated the lottery tickets will be used with a player device 500 to enhance user experience, the invention is not limited thereto since game data, including winnings are stored on the card in the QR code (or in the alternative Bar Code). As such, a purchaser may simply purchase the lottery ticket and redeem the card directly.

What is claimed:

1. A game system comprising:
a central host computer having various ticket specific computer files;
a retail establishment having a plurality of lottery tickets and a POS system through which the plurality of lottery tickets are purchased; and
a player device, wherein the lottery tickets have at least one play area covered by a scratch off coating and at least one of a website, QR code, and bar code readable by the player device, wherein when the one of the QR code and the bar code is read by the player device or when the website is entered into the player device the player device receives instructions from a server to select avatars and game preferences.

2. The game system of claim 1, wherein the one of the QR code and the bar code includes data identifying a type of game.

3. The game system of claim 1, wherein the website generates a summary screen summarizing lottery ticket winnings which may be redeemed.

4. A lottery ticket comprising:
one of a QR code and a bar code readable by a player device, the one of the QR code and the bar code having game data indicative of winnings associated with the card.

5. The lottery ticket of claim 4, wherein the one of the QR code and the bar code includes information indicating the type of game the lottery ticket is associated with.

6. The lottery ticket of claim 5, wherein the one of the QR code and the bar code includes website information such than when a player device scans the one of the QR code and the bar code the player device is directed to a website.

7. The lottery ticket of claim 4, wherein the one of the QR code and the bar code further includes information indicating the type of game the lottery ticket is associated with and website information such than when a player device scans the one of the QR code and the bar code the player device is directed to a website and the player devices sends the information indicating the type of game the lottery ticket is associated with to the website which streams information back to the player device to provide the player an enhanced user experience.

8. The lottery ticket of claim 7, wherein the lottery ticket includes at least one play area covered by a scratch off coating.

9. The lottery ticket of claim 7, wherein the one of the QR code and the bar code is covered by a scratch off coating.

10. A game system comprising:
a host computer hosting a website;
a lottery ticket having one of a QR code, a bar code, and a website address; and
a player device configured to interface with the website by one of scanning the one of the bar code and QR code or entering the website address, wherein the host computer responds by providing the player device digital information enabling the player device to generate images and animations.

11. The game system of claim 10, wherein the host computer provides data to the player device enabling a player to select at least of an avatar and a theme.

12. The game system of claim 11, wherein the host computer provides a summary screen providing a summary of winnings associated with the lottery ticket.

13. The game system of claim 10, wherein the one of a QR code and a bar code is readable by a scanner of the player device and the one of the QR code and the bar code has game data indicative of winnings associated with the lottery ticket.

14. The game system of claim 13, wherein the one of the QR code and the bar code includes information indicating the type of game the lottery ticket is associated with.

15. The game system of claim 14, wherein the one of the QR code and the bar code includes website information such than when the player device scans the one of the QR code and the bar code the player device is directed to the website.

16. The game system of claim 10, wherein the one of the QR code and the bar code further includes information indicating the type of game the lottery ticket is associated with and website information such than when a player device scans the one of the QR code and the bar code the player device is directed to a website and the player devices sends the information indicating the type of game the lottery ticket is associated with to the website which streams information back to the player device to provide the player an enhanced user experience.

17. The game system of claim 16, wherein the lottery ticket includes at least one play area covered by a scratch off coating.

18. The lottery ticket of claim 16, wherein the one of the QR code and the bar code is covered by a scratch off coating.

19. The game system of claim 10, further comprising:
a point of sale system where the lottery ticket is purchased.

20. The game system of claim 10, wherein player device includes a touch screen configured to generate an avatar and a game theme based on input from the player through the player device.
